(19) United States
(12) Patent Application Publication
(10) Pub. No.: US 2004/0164141 A1
(43) Pub. Date: Aug. 26, 2004

(54) Automatic teller machine and bill unit with built-in camera

(75) Inventors: Hiroyuki Egami, Kawasaki (JP); Akinori Ohta, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/747,673

(22) Filed: Dec. 30, 2003

Related U.S. Application Data
(63) Continuation of application No. PCT/JP01/07500, filed on Aug. 30, 2001.

(51) Int. Cl. G06F 17/60

(52) U.S. Cl. 235/379

(57) ABSTRACT

An automatic teller machine for the automatic withdrawal and deposit of money in accordance with an operation of a customer, wherein a security camera able to capture an image when the shutter is opened is provided at a predetermined location in a bill receptacle opened and closed by a shutter together with a sensor for detecting the insertion of a hand into the bill receptacle and wherein when insertion of a hand into the bill receptacle by a customer when taking out bills is detected, an image including the hand of the customer is captured by the security camera. As a result, it is possible to capture the image of the customer for use in security purposes without allowing the customer to become aware of the existence of the camera.

### CROSS-REFERENCE TO RELATED APPLICATIONS

This application is a continuation application of PCT/JP01/07500, filed on Aug. 30, 2001, the contents being incorporated herein by reference.

### TECHNICAL FIELD

The present invention relates to an automatic teller machine and a bill unit with a built-in camera, more particularly relates to an automatic teller machine and bill unit with a built-in camera able to monitor the state of motion of the hand of a customer. Explained in more detail, it relates to an automatic teller machine and a bill unit with a built-in camera able to use the built-in camera to monitor the motion of the hand of a customer when the customer withdraws or deposits money.

### BACKGROUND ART

Conventionally, automatic teller machines handling cash (hereinafter referred to as “ATMs”) have been equipped with security cameras at parts of the ATMs or outside of the ATMs so as to monitor-cash transactions of customers.

The security cameras built into the ATMs, however, have been installed at the tops of the ATMS, so under ordinary conditions have only been able to capture images of the upper torsos of customers withdrawing and depositing cash and have not been able to capture images of the state of motion of the hands of the customers. Therefore, in conventional ATMs, it was not possible to leave behind a surveillance record of customers unintentionally forgetting to take their cash etc. Further, the security cameras installed at conventional ATMs had lenses at easily visible positions at the tops of the ATMs, so customers easily became aware of the existence of the security cameras and therefore there was the defect that if mischievous or malicious customers etc. blocked the lenses when making transactions, the images of the customers could no longer be captured.

### DISCLOSURE OF THE INVENTION

Therefore, an object of the present invention is to solve the problem of a conventional ATM with a built-in security camera and provide an automatic teller machine installing the security camera at a nonvisible location of the ATM so as not to allow the customer to become aware of the existence of the security camera and monitoring the state of movement of cash by the hand of the customer when withdrawing or depositing cash, in particular when withdrawing cash, so as to enable confirmation when trouble occurs over money and identification of individuals. Another object is to provide an automatic teller machine and bill unit with a built-in camera setting a security camera at a nonvisible location of the ATM so as to enable protection of the security camera itself.

The ATM of the present invention for achieving the above objects is shown by the following first aspect to sixth aspect.

The ATM of the first aspect is an ATM for automatic withdrawal and deposit of money in accordance with an operation by a customer, characterized by being provided with a bill receptacle opened and closed by a shutter and a security camera positioned at a predetermined location in the bill receptacle and able to capture an image when said shutter is opened.

The ATM of the second aspect is an ATM of the first aspect characterized in that sensors for detecting insertion of a hand into the bill receptacle are provided at two predetermined locations in said bill receptacle inside of said shutter, and said security camera operates to capture the image at least when said sensors detect the insertion of a hand into said bill receptacle.

The ATM of the third aspect is an ATM of the first aspect characterized in that sensors for detecting insertion of a hand into the bill receptacle are provided at two predetermined locations in said bill receptacle inside of said shutter, and one of said sensors is set in the vicinity of the bills at said bill receptacle and said security camera operates to capture the image when that sensor detects bills being taken out.

The ATM of the fourth aspect is an ATM of the second or third aspect characterized in that it is provided with a time counting means for counting the time after said bill receptacle is opened by said shutter, and said security camera operates to capture the image when a count of said time counting means reaches a predetermined time in the state without the insertion of a hand into the bill receptacle being detected by said sensors.

The ATM of the fifth aspect is an ATM of the first to fourth aspects characterized in that a second security camera is installed at another portion of said ATM in addition to the security camera installed in said bill receptacle.

The ATM of the sixth aspect is an ATM of the fifth aspect characterized in that the ranges of capture of the security camera installed in said bill receptacle and said second security camera are made different so as to capture the image of the customer in a state without any dead angles.

The bill unit with a built-in security camera of the present invention for achieving the above objects is a bill unit for the withdrawal and deposit of bills built into an automatic teller machine for automatic withdrawal and deposit of money in accordance with an operation by a customer, characterized by being provided with a bill holder positioned at a back side of an opening/closing type shutter provided at said automatic teller machine, a sensor provided at an opening of said bill holder and detecting insertion of the hand of a customer into said bill holder, and a security camera positioned in the vicinity of said bill holder and capturing an image when said sensor detects insertion of the hand of a customer.

According to the ATM of the present invention, it is possible to monitor the state of movement of cash by the hand of a customer when withdrawing or depositing cash, in particular when withdrawing cash, without allowing the customer to become aware of the existence of the security camera, so confirmation when trouble over money occurs and identification of the individual involved become possible. Further, since the existence of the security camera is difficult for the customer to become aware of, it is also possible to protect the security camera itself.

Further, the bill unit with the built-in security camera of the present invention can be sold as a separate component, so can be introduced into various ATMS.

### BRIEF DESCRIPTION OF DRAWINGS

These and other objects, features, advantages, etc. of the present invention are explained in detail below in accordance with the embodiments shown in the attached drawings, in which:

FIG. 1A is a perspective view of the appearance of a conventional ATM;

FIG. 1B is a partially enlarged sectional view of the structure of a bill receptacle of a conventional ATM;

FIG. 2A is a side view of an ATM for explaining the position of installation of a security camera provided in a conventional ATM, its range of capture, and the location of the bill receptacle;

FIG. 2B shows an image of a video of a customer captured by the security camera of FIG. 2A;

FIG. 3A is a perspective view of the appearance of an ATM of the present invention;

FIG. 3B is a partially enlarged perspective view of the structure of the bill receptacle of the ATM of the present invention;

FIG. 4A is a partially enlarged perspective view of an embodiment of the arrangement of the optical axes of the hand insertion sensors provided in the bill receptacle of the ATM of the present invention;

FIG. 4B is a partially enlarged perspective view of the mounting position of the hand insertion sensors provided in the bill receptacle of FIG. 4A and the arrangement of the optical axes of the sensor beams;

FIG. 5A is a side view of an ATM for explaining the position of installation of a security camera provided in the ATM of the present invention and its range of capture and the positions of a card unit, bill unit, and controller;

FIG. 5B is a view of an image of the video of a customer captured by the security camera of FIG. 5A;

FIG. 6 is a block diagram of the configuration showing connections among components of the controller provided inside the ATM of the present invention;

FIG. 7 is a view of the configuration of data showing an example of the content of the video data captured by the security camera of the ATM of the present invention;

FIG. 8 is a flow chart of the routine of an example of a withdrawal operation of a controller built into the ATM of the present invention;

FIG. 9 is a flow chart of the routine of another example of a withdrawal operation of a controller built into the ATM of the present invention; and

FIG. 10 is a perspective view of a bill unit with a security camera to be built into an ATM of the present invention.

### BEST MODE FOR CARRYING OUT THE INVENTION

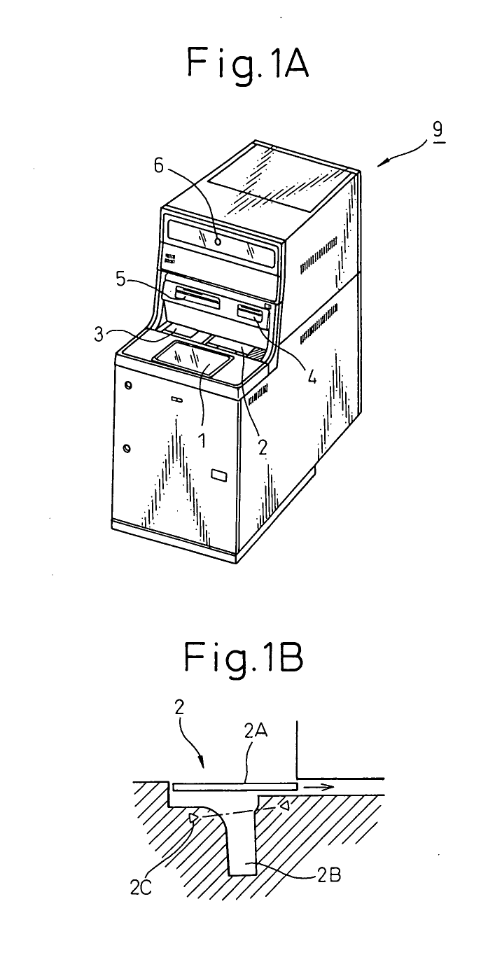

FIG. 1A shows the appearance of a conventional ATM 9. The front side of the ATM 9 is shaped as a table. This portion has a touch panel type input panel. At the rear of the touch panel 1 are arrayed a bill receptacle 2 and a coin receptacle 3. Above these are provided a money card slot 4 and a passbook slot 5. Further, the top of the front panel of the ATM 9 is provided with a security camera 6.

FIG. 1B is a partially enlarged sectional view of the structure of the bill receptacle 2 of the conventional ATM 9 shown in FIG. 1A. The bill receptacle 2 is usually blocked by a shutter 2A opening and closing in the horizontal direction. When the shutter 2A opens, the bill holder 2B holding the bills appears. Deposited bills and withdrawn bills are held here once in this bill holder 2B. The opening of the bill holder 2B is provided with a hand insertion sensor 2C provided with a light emitting part and a light receiving part and can detect the deposition of bills or the withdrawal of bills by a customer.

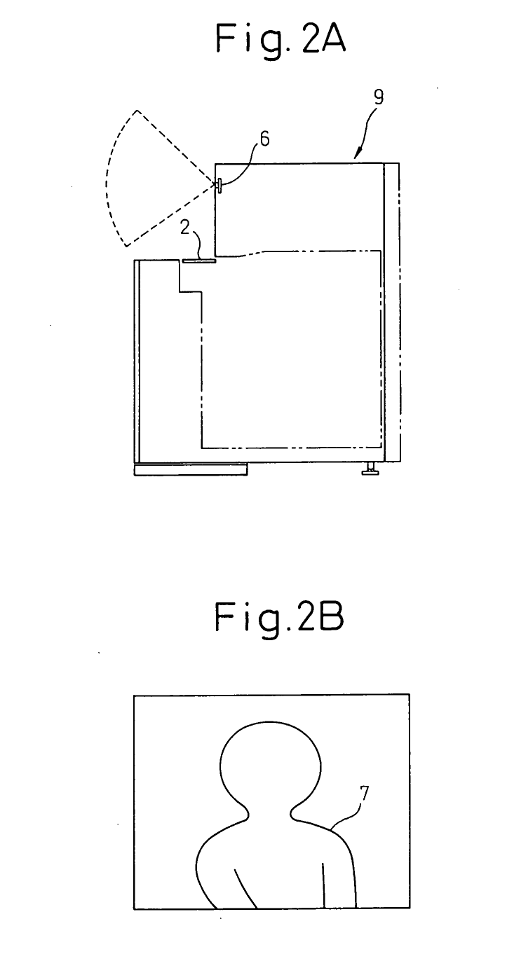

FIG. 2A shows the position of installation of the security camera 6 provided in the conventional ATM 9 and its range of capture and the position of the bill receptacle 2. The security camera 6 is installed at the top of the front panel of the ATM 9, so when the security camera 6 captures the image of a customer, a video of the customer 7 such as shown in FIG. 2B is obtained.

Since the security camera 6 is installed at the top of the front panel of the ATM 9 in this way, under ordinary conditions, only the image of the upper torso of the customer 7 withdrawing or depositing cash can be captured. The state of motion of the hand of the customer 7 could not be captured. Therefore, with the conventional ATM 9, it was not possible to leave behind a surveillance record of the customer 7 unintentionally forgetting to take his or her cash. Further, the security camera 6 installed in the conventional ATM 9 had the lens at an easily visible position of the front panel of the ATM 9, so the customer 7 could easily notice the existence of the security camera 6. When there was a mischievous or malicious customer 7, there was the problem that-the lens was blocked at the time of the transaction and therefore the image of the customer could not be captured.

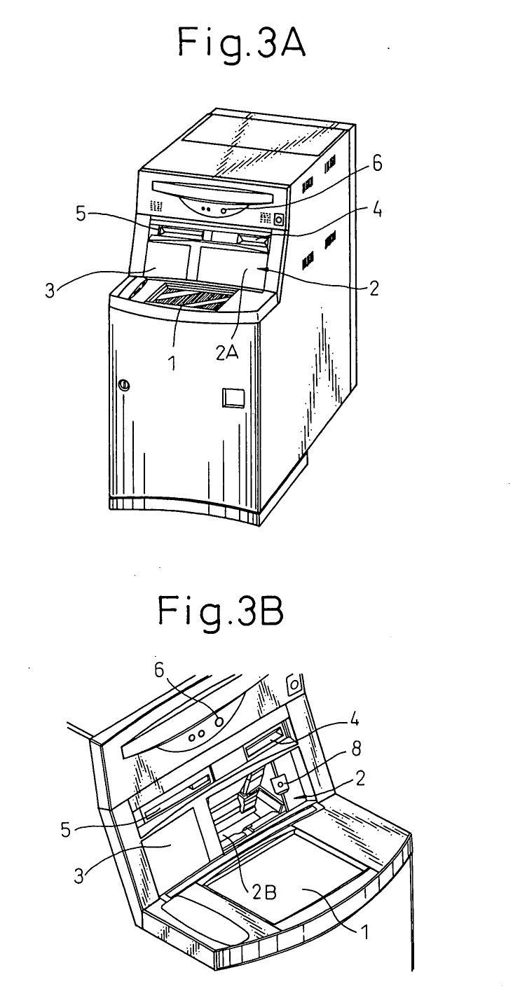

FIG. 3A shows the appearance of an ATM 10 of the present invention. Note that to facilitate understanding of the explanation, portions the same as the conventional ATM 9 explained in FIG. 1A are given the same reference numerals in the explanation.

In the ATM 10 of the present invention as well, the front surface is shaped as a table. This portion is provided with a touch panel type input panel 1. Further, behind this touch panel 1 are arranged a bill receptacle 2 and a coin receptacle 3. Above these are provided a money card slot 4 and a passbook slot 5. At the top of the front panel of the ATM 10 is provided a security camera 6.

Here, the differences between the conventional ATM 9 explained in FIG. 1A and the ATM 10 of the present invention will be explained. In the conventional ATM 9, the shutter 2A opening/closing the bill receptacle 2 is provided in a table shape and moved in the horizontal direction. On the other hand, in the ATM 10 of the present invention, the portion of the front panel of the ATM 10 where the money card slot 4 and passbook slot 5 are provided is slanted back, and a shutter 2A is provided at the slanted part of the front panel. Therefore, in the ATM 10 of the present invention, the shutter 2A descends to open the bill receptacle 2.

FIG. 3B is a partially enlarged perspective view of the part of the bill receptacle 2 of the ATM 10 in the state with the shutter 2A of FIG. 3A opened. Deep inside it is provided a bill holder 2BA in the same way as the conventional example. Further, in the present invention, a security camera 8 is provided at a position in the bill receptacle 2 hidden by the shutter 2A and not visible from the outside when the shutter 2A is closed. The installation position of the security camera 8 should be a position which can view the entire bill holder 2B.

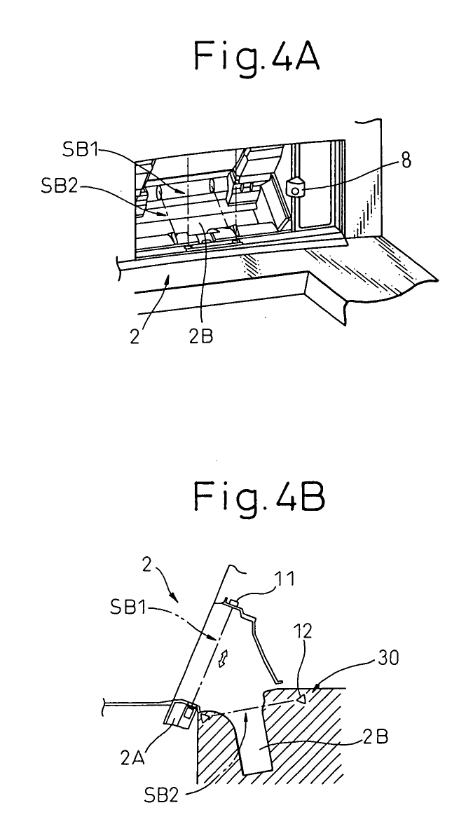

Further, the bill receptacle 2 of the ATM 10 of the present invention, as shown in FIGS. 4A and 4B, is provided with two hand insertion sensors 11, 12. The first hand insertion sensor 11 and second hand insertion sensor 12 are comprised of light emitting parts and light receiving parts. Sensor beams SB1 and SB2 run between them. Infrared sensors may be used for the first hand insertion sensor 11 and the second hand insertion sensor 12, but it is also possible to use motion detection sensors detecting moving objects etc. as well.

Note that the second hand insertion sensor 12 in the present invention, as explained in FIG. 1B, was also provided in the conventional machine. In the past as well, this sensor detected a customer's insertion of a hand into the bill holder 2B, so it is possible to use this sensor as it is.

The first hand insertion sensor 11 is provided near the back surface of the shutter 2A. The sensor beam SB1 of the first hand insertion sensor 11 is a beam parallel to the direction of opening/closing of the shutter 2A of the bill receptacle 2. On the other hand, the second hand insertion sensor 12 is provided in the vicinity of the opening of the bill holder 2B in the same way as in the conventional ATM 9. The sensor beam SB2 of the second hand insertion sensor 12 is a beam cutting across the opening of the bill holder 2B and is designed to be able to detect the insertion of bills by the customer into the bill holder 2B or the removal of bills from the bill holder 2B. In this way, in the present invention, it becomes possible to capture an image from deep in the bill holder 2B of the ATM 10 and is possible to expand the range of capture for a short customer such as a customer using a wheelchair.

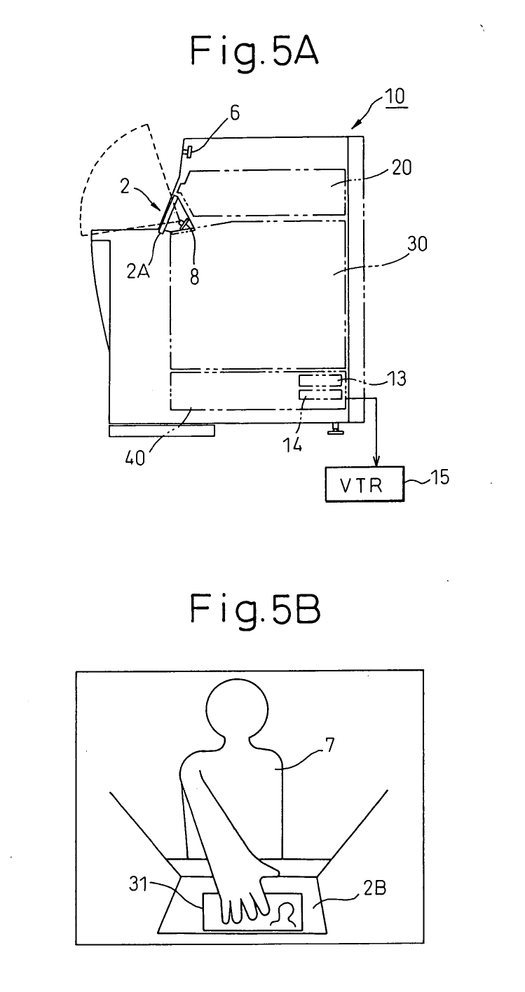

FIG. 5A explains the installation position and range of capture of the security camera 8 provided at the ATM 10 of the present invention and the positions of the card unit 20, bill unit 30, and controller 40 built in the ATM 10. In the ATM 10 of the present invention, the security camera 6 provided in the conventional ATM 9 is also kept without being removed. The card unit 20 is provided at the rear of the money card slot 4 shown in FIG. 3A. The bill unit 30 is provided at the rear bottom of the bill receptacle 2. Further, at the bottommost part of the ATM 10, the controller 40 for controlling the operations of the devices inside the ATM 10 is provided.

The video captured by the security cameras 6, 8 is designed to be recorded in multiple as a failsafe against loss of recordings. For example, in the embodiment of FIG. 5A, the media for recording video captured by the security cameras 6, 8 includes a CD-R drive 13 and a hard disk drive (hereinafter referred to as the “HDD”) 14 built into the controller 40 and a video tape recorder (hereinafter referred to as a “VTR”) 15 provided outside of the ATM 10. The image recorded in the VTR 15 can be monitored by a supervisor etc. by provision of a video monitor outside of the ATM 10. In this way, in this embodiment, even if two of the recorders break down, it is possible to record and store the image by the remaining one.

Note that in this embodiment, the recorders built into the controller 40 were explained using the CD-R drive 13 and HDD 14 as examples, but the recorders built into the controller 40 are not limited to these. It is also possible to use a magneto-optic disk (MO) drive, digital versatile disk (DVD) drive, or other recorder using a recording medium. That is, the recording media used in the present invention are not particularly limited in type so long as they can be connected to a computer.

The video of the customer captured by the security camera 6 is the same as that in the past. Further, the video of the customer 7 captured by the security camera 8 shows down to the hand of the customer 7 as shown in FIG. 5B since the security camera 8 is provided in the bill receptacle 2. Therefore, in the ATM 10 of the present invention, it is possible to record the state of the bills 31 being taken out from the bill holder 2B of the bill receptacle 2 by the customer 7.

Therefore, in the ATM 10 of the present invention, by operating both the conventionally provided security camera 6 and the security camera 8 newly provided in the present invention, it is possible to record both the image of the state of the surroundings including the upper torso of the customer 7 withdrawing or depositing cash and the image of the hand of the customer 7 at the time of withdrawal. Therefore, in the ATM 10 of the present invention, it is possible to kept a surveillance record of a customer 7 unintentionally forgetting to take his or her cash etc. Further, the security camera 8 installed in the ATM 10 of the present invention is not visible until the shutter 2A of the bill receptacle 2 opens, and, once the shutter 2A opens, the attention of the customer 7 shifts to the bills stored in the bill holder 2B, so its existence is hard for a customer 7 to notice.

Note that the conventionally provided security camera 6 may also be made a dummy and only the security camera 8 newly provided in the present invention made to operate.

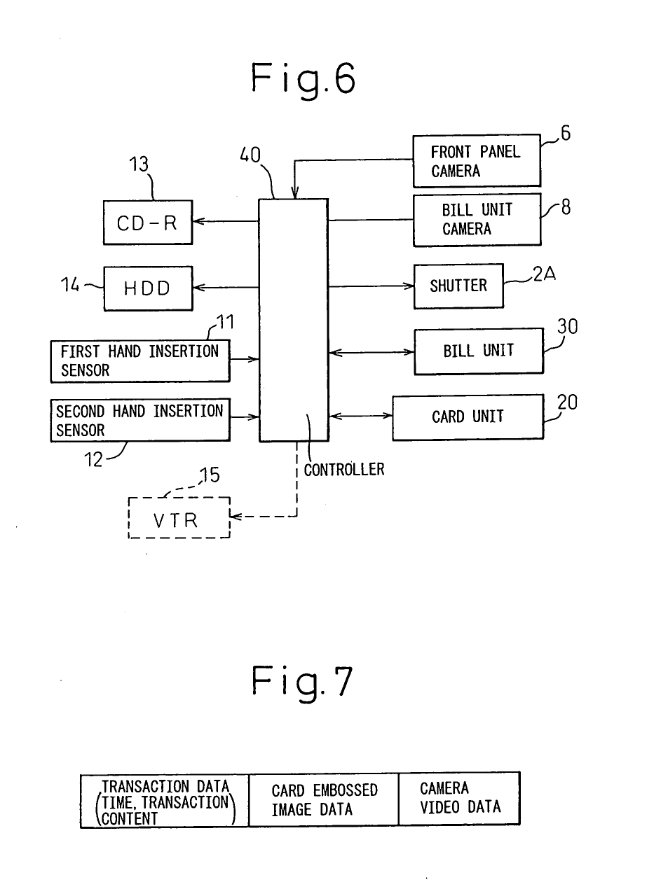

FIG. 6 shows the connections of the devices provided inside the ATM 10 of the present invention. As shown in this figure, the shutter 2A, front panel camera 6, bill unit camera 8, the first and second hand insertion cameras 11, 12, CD-R drive 13, HDD 14, card unit 20, and bill unit 30 are connected to the controller 40. Further, the controller 40 records the video in the VTR 15 provided outside of the ATM 10 as well.

FIG. 7 is a view of the configuration of the data showing an embodiment of the content of the video data captured by the security cameras 6, 8 of the ATM 10 of the present invention and recorded in the CD-R drive 13, HDD 14, and VTR 15. The recorded video data includes (1) transaction data including the transaction time and transaction content, (2) card embossed image data captured by the security camera 6 (account number, member number, expiration date, name, etc. printed on the surface of the money card or credit card by embossing), and video data captured by the security cameras 6, 8.

By reading the card embossing, it is possible to discriminate counterfeit cards without embossing, with differences in the name in the transaction data and the embossed name, etc.

In this way, in the present invention, the image and video recorded by the recorders built into the ATM 10 are stored together with the customer data, so by later referring to a past abnormal operation of a customer during use of the ATM 10 such as forgetting to take the cash or not taking all of it or card insertion, it is possible to confirm if the same person has performed that operation. Further, while the recording by the VTR 15 requires review of the entire video in order to refer to a specific recorded image, the recording mechanism of a CD-R drive 13, HDD 14, etc. built into the ATM 10 enables search for a desired part of the video by an identification code of the operator and therefore enables immediate confirmation. Further, in the future, since the video is stored as data, confirmation of the identity of the customer by comparison of customer data and the recorded image becomes possible.

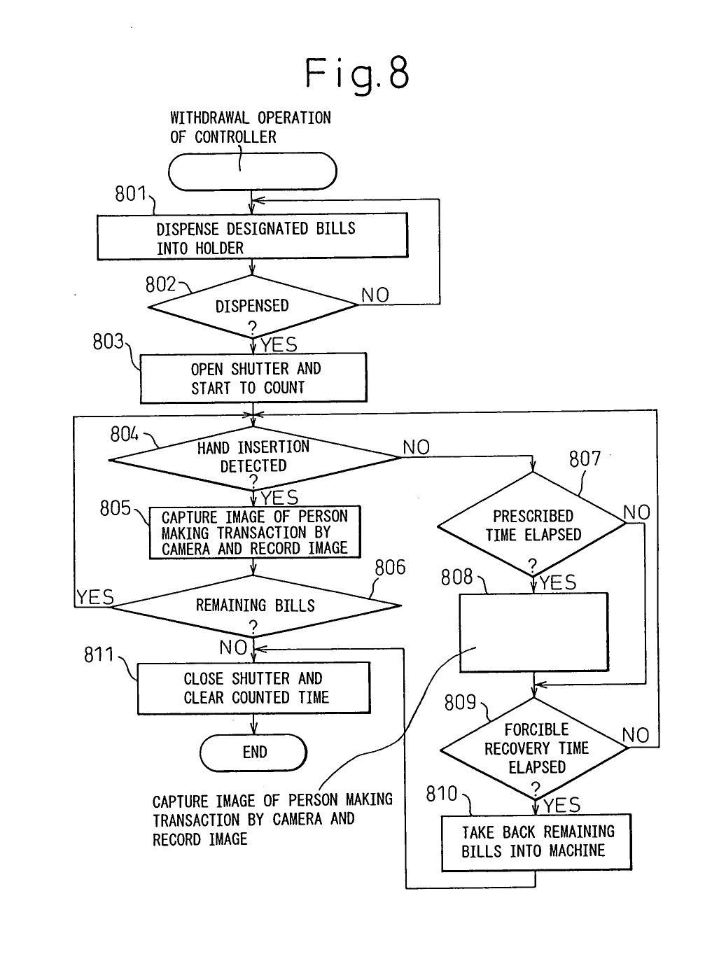

FIG. 8 is a flow chart of the routine of an example of an operation for withdrawal of bills in the bill unit 30 in the withdrawal and deposit operations of the controller 40 built into the ATM 10 of the present invention. This routine is started when a customer touches the “WITHDRAWAL” button displayed on the input panel 1 shown in FIG. 3A. Note that the flow chart of FIG. 8 describes the routine after the end of all routines such as the confirmation of the PIN of the customer after insertion of his or her card and confirmation of the withdrawal amount.

At step 801, the bills designated by the bill unit 30 are dispensed into the holder 2B. At step 802, it is judged if the bills were able to be dispensed. When the bills were not able to be dispensed, the routine returns to step 801, where dispensing of cash is continued, while when the bills could be dispensed, the routine proceeds to step 803, where the shutter 2A is opened and simultaneously time starts to be counted.

At step 804, it is judged by the hand insertion sensors 11, 12 if the insertion of the hand of the customer has been detected. When it has been detected, the routine proceeds to step 805, where the security cameras 6, 8 capture the image of the person making the transaction (customer) and record the image in the afore-mentioned CD-R drive 13, HDD 14, and VTR 15. At step 806, it is judge if the holder 2B has any bills left in it. When bills are left in it, the routine returns to step 804, while when there are no bills left in it, the routine proceeds to step 811. At step 811, the shutter 2A is closed, the counted time is cleared, and the routine is ended.

On the other hand, when the insertion of a hand is not detected at step 804, the routine proceeds to step 807, where it is judged if a prescribed time has elapsed from when the shutter 2A was opened. When the prescribed time has not elapsed at step 807, the routine proceeds to step 809, where it is judged if the time for forcible recovery of the bills has elapsed. Further, when the prescribed time has elapsed at step 807, at step 808, the image of the person making the transaction (customer) is captured by the security cameras 6, 8 and the image is recorded in the afore-mentioned CD-R drive 13, HDD 14, and VTR 15.

When the time for forcible recovery has not elapsed in the judgment of step 809 whether the time for forcible recovery of the bill has elapsed, the routine returns to step 804, where whether the hand of the customer has been inserted is detected. When the time for forcible recovery has elapsed, the routine proceeds to step 810, where the bills remaining in the holder 2B are forcibly taken back into the machine and the routine ended.

In this way, in the present invention, even when a customer forgets to take his or her bills at the time of withdrawal and the remaining bills are forcibly taken back into the ATM 10, the image of the hand of the customer captured by the security camera 8 is kept in the CD-R drive 13, HDD 14, or VTR 15, so it is possible to easy confirm this fact when the customer realizing he or she has forgotten to take the cash later visits the bank to reclaim the forgotten money and therefore it is possible to prevent trouble with customers over money.

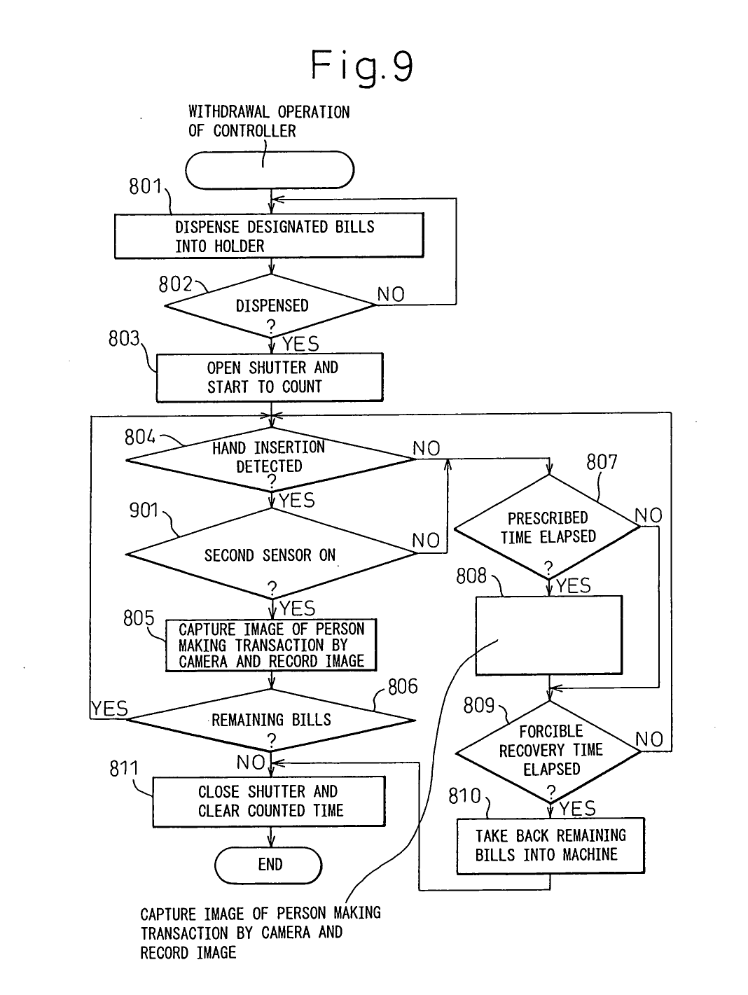

FIG. 9 is a flow chart of the routine of another example of a withdrawal operation among the withdrawal and deposit operations of the controller 40 built in the ATM 10 of the present invention. This routine differs from the routine explained in FIG. 8 only on the point that an image of the customer is captured by the security camera 8 only when the second hand insertion sensor 12 installed in the opening of the bill holder 2B of the bill receptacle 2 detects insertion of a hand. Therefore, parts of the routine the same as the routine explained in FIG. 8 are assigned the same step numbers and explanations thereof are omitted.

Explaining only the point of difference of the routine of FIG. 9 from the routine of FIG. 8, in the routine of FIG. 9, at step 804, the first hand insertion sensor 11 detects whether a hand of the customer has been inserted. When the first hand insertion sensor 11 detects the insertion of the hand of the customer, at step 805, the second hand insertion sensor 12 detects whether the hand of the customer has been inserted. Further, when the second hand insertion sensor 12 does not detect insertion of the hand of the customer, the routine proceeds to step 807, while when the second hand insertion sensor 12 detects the insertion of the hand of the customer, the routine proceeds to step 805, where the image of the person making the transaction (customer) is captured and the video is recorded in the afore-mentioned CD-R 13, HDD 14, and VTR 15. In this embodiment, the camera captures the image of the customer when the second hand insertion sensor 12 detects the insertion of the hand of the customer, so it is possible to capture an image of the person actually taking out the bills.

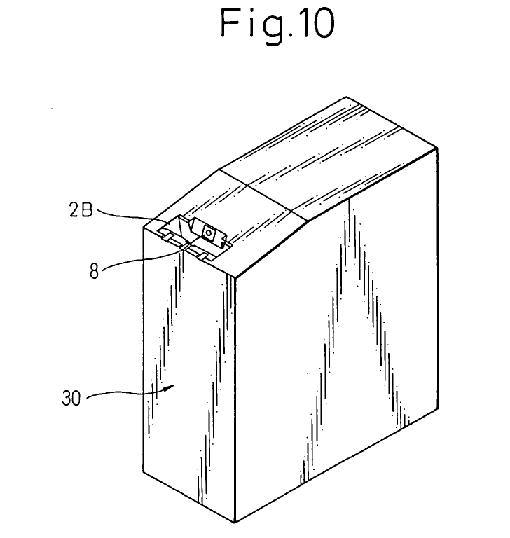

FIG. 10 is a perspective view showing the configuration of the bill unit 30 provided with the security camera 8 as a separate unit. From this figure, it will be understood that the security camera 8 is set deep in the bill holder 2B of the bill unit 30. In this way, the bill unit 30 provided with the security camera 8 of the present invention can be sold as a separate unit as well.

### INDUSTRIAL APPLICABILITY

According to the configuration of the ATM shown in the present invention, it is possible to make the customer monitoring at the time of handling cash more reliable and help prevent tampering with the security camera etc. Further, it is possible to divert the various sensors of the units of a conventional ATM to serve as triggers for capturing images of customers making cash transactions, so it is possible to capture images more accurately. Further, the customer is not longer made aware of being captured by the security camera due to the ordinary appearance.

Further, the security camera set in the vicinity of the bill holder shown in the present invention can be built into the bill unit, so it is possible to sell only the bill unit and thereby apply the present invention to a broad range of machines.

1. An automatic teller machine for automatic withdrawal and deposit of money in accordance with an operation by a customer,
said automatic teller machine characterized by being provided with:
a bill receptacle opened and closed by a shutter and
a security camera positioned at a predetermined location in said bill receptacle and able to capture an image when said shutter is opened.

2. An automatic teller machine as set forth in claim 1,
said automatic teller machine characterized in that
sensors for detecting insertion of a hand into the bill receptacle are provided at two predetermined locations in said bill receptacle inside of said shutter, and
said security camera operates to capture the image at least when said sensors detect the insertion of a hand into said bill receptacle.

3. An automatic teller machine as set forth in claim 1,
said automatic teller machine characterized in that
sensors for detecting insertion of a hand into the bill receptacle are provided at two predetermined locations in said bill receptacle inside of said shutter, and
one of said sensors is set in the vicinity of the bills at said bill receptacle and said security camera operates to capture the image when that sensor detects the bills being taken out.

4. An automatic teller machine as set forth in claim 2,
said automatic teller machine characterized in that
it is provided with a time counting means for counting the time after said bill receptacle is opened by said shutter, and
said security camera operates to capture the image when a count of said time counting means reaches a predetermined time in the state without the insertion of a hand into the bill receptacle being detected by said sensors.

5. An automatic teller machine as set forth in claim 1,
said automatic teller machine characterized in that a second security camera is installed at another portion of said automatic teller machine in addition to the security camera installed in said bill receptacle.

6. An automatic teller machine as set forth in claim 5,
said automatic teller machine characterized in that the ranges of captured of the security camera installed in said bill receptacle and said second security camera are made different so capture the image of the customer in a state without any dead angles.

7. An automatic teller machine as set forth in claim 2,
said automatic teller machine characterized in that a second security camera is installed at another portion of said automatic teller machine in addition to the security camera installed in said bill receptacle.

8. An automatic teller machine as set forth in claim 7,
said automatic teller machine characterized in that the ranges of captured of the security camera installed in said bill receptacle and said second security camera are made different so capture the image of the customer in a state without any dead angles.

9. An automatic teller machine as set forth in claim 3,
said automatic teller machine characterized in that
it is provided with a time counting means for counting the time after said bill receptacle is opened by said shutter, and
said security camera operates to capture the image when a count of said time counting means reaches a predetermined time in the state without the insertion of a hand into the bill receptacle being detected by said sensors.

10. An automatic teller machine as set forth in claim 10,
said automatic teller machine characterized in that a second security camera is installed at another portion of said automatic teller machine in addition to the security camera installed in said bill receptacle.

11. An automatic teller machine as set forth in claim 10,
said automatic teller machine characterized in that the ranges of captured of the security camera installed in said bill receptacle and said second security camera are made different so capture the image of the customer in a state without any dead angles.

12. An automatic teller machine as set forth in claim 3,
said automatic teller machine characterized in that a second security camera is installed at another portion of said automatic teller machine in addition to the security camera installed in said bill receptacle.

13. An automatic teller machine as set forth in claim 12,
said automatic teller machine characterized in that the ranges of captured of the security camera installed in said bill receptacle and said second security camera are made different so capture the image of the customer in a state without any dead angles.

14. An automatic teller machine as set forth in claim 4,
said automatic teller machine characterized in that a second security camera is installed at another portion of said automatic teller machine in addition to the security camera installed in said bill receptacle.

15. An automatic teller machine as set forth in claim 14,
said automatic teller machine characterized in that the ranges of captured of the security camera installed in said bill receptacle and said second security camera are made different so capture the image of the customer in a state without any dead angles.

16. A bill unit for the withdrawal and deposit of bill built into an automatic teller machine for automatic withdrawal and deposit of money in accordance with an operation by a customer,
said bill unit characterized by being provided with
a bill holder provided at said automatic teller machine and positioned at a back side of an opening/closing type shutter,
a sensor provided at an opening of said bill holder and detecting insertion of the hand of a customer into said bill holder, and
a security camera positioned in the vicinity of said bill holder and capturing an image when said sensor detects insertion of the hand of a customer.
